(19) United States
(12) Patent Application Publication
(10) Pub. No.: US 2012/0000763 A1
(43) Pub. Date: Jan. 5, 2012

(54) SEAWATER DESALINATION DEVICE

(76) Inventors: Chun-Feng Lee, Yunlin County (TW); Yu-Yu Lin, Nantou County (TW); Tsung-Ching Chen, Taichung City (TW)

(21) Appl. No.: 12/856,335

(22) Filed: Aug. 13, 2010

(30) Foreign Application Priority Data
Jun. 30, 2010 (TW) 99212464

(51) Int. Cl. B01D 1/00; C02F 9/02

(52) U.S. Cl. 202/176

(57) ABSTRACT

A seawater desalination device includes a seawater reservoir having a bottom wall and adapted for holding seawater, an evaporator adapted for evaporating the seawater held in the seawater reservoir into water vapor, osmosis membrane modules installed in the seawater reservoir and spaced above the bottom wall of the seawater reservoir, each osmosis membrane having membranes for the passing of the water vapor evaporated by the evaporator and a water vapor accumulation chamber surrounded by the membranes and a suction pipe connected to the water vapor accumulation chamber, and a pump unit having a pipe connected to the suction pipe of each osmosis membrane module and adapted for drawing water vapor out of the water vapor accumulation chamber of each osmosis membrane module.

### BACKGROUND OF THE INVENTION

1. Field of the Invention

The present invention relates to seawater treatment technology and more particularly, to a seawater desalination device.

2. Description of the Related Art

Distillation, high-pressure membrane filtration and membrane filter techniques are commonly used in seawater desalination devices for seawater desalination. However, membrane filtration requires a wall surface to condense water vapor into water drops. Due to the effects of water saturation and temperature, the speed of condensing water vapor into water drops is limited, and a large amount of energy will be consumed to desalinate seawater. Further, the known seawater desalination devices require a heat exchanging system for enabling water vapor to be condensed into water drops slowly. However, a heat exchanging system for this purpose has a complicated structure.

In general, conventional seawater desalination devices are still not satisfactory in function. An improvement in this regard is necessary.

### SUMMARY OF THE INVENTION

The present invention has been accomplished under the circumstances in view. It is the main object of the present invention to provide a seawater desalination device, which desalinates seawater efficiently and rapidly, avoiding salt content or other substances of seawater from being mixed in desalinated water.

To achieve this and other objects of the present invention, a seawater desalination device comprises a seawater reservoir having a bottom wall and adapted for holding seawater, an evaporator that held in the seawater reservoir is adapted for evaporating the seawater into water vapor, osmosis membrane modules installed in the seawater reservoir and spaced above the bottom wall of the seawater reservoir, each osmosis membrane having membranes for the passing of the water vapor evaporated by the evaporator and a water vapor accumulation chamber surrounded by the membranes and a suction pipe connected to the water vapor accumulation chamber, and a pump unit having a pipe connected to the suction pipe of each osmosis membrane module and adapted for drawing water vapor out of the water vapor accumulation chamber of each osmosis membrane module.

### BRIEF DESCRIPTION OF THE DRAWINGS

FIG. 1 is a sectional front view of a seawater desalination device in accordance with the present invention.

FIG. 2 is a sectional side view of the seawater desalination device in accordance with the present invention.

FIG. 3 is a schematic partial sectional view of one osmosis membrane module used in the seawater desalination device in accordance with the present invention.

### DETAILED DESCRIPTION OF THE INVENTION

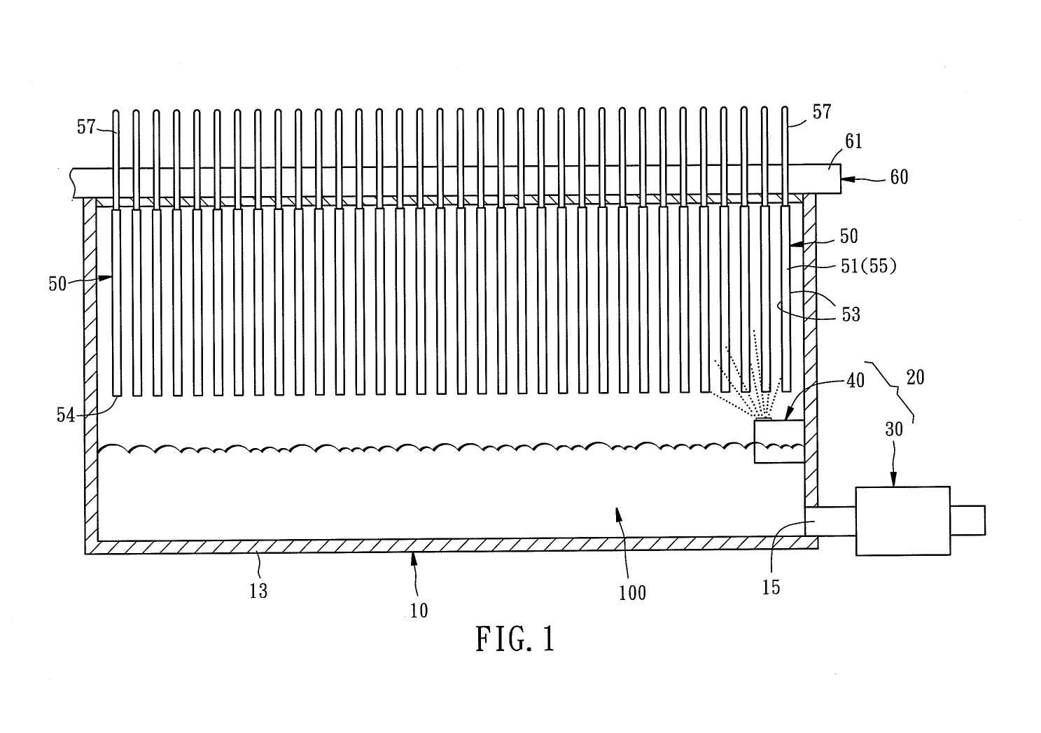

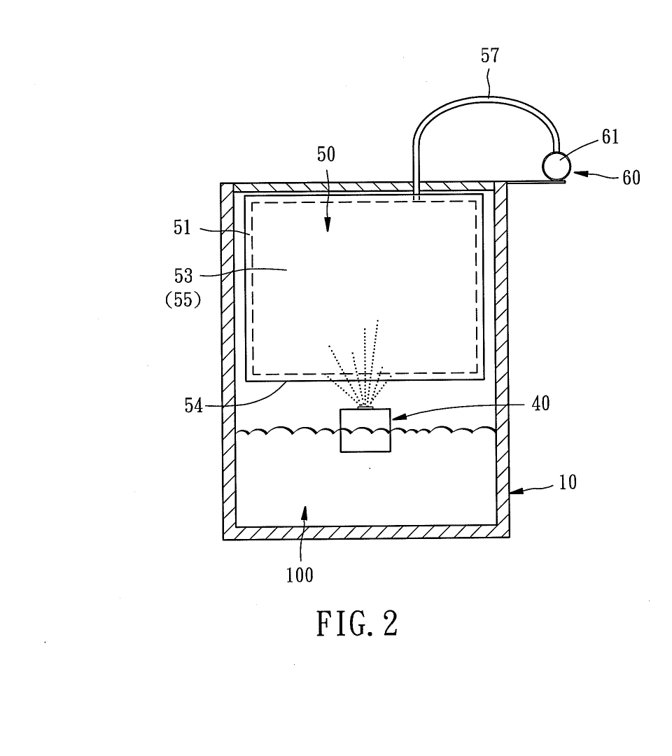

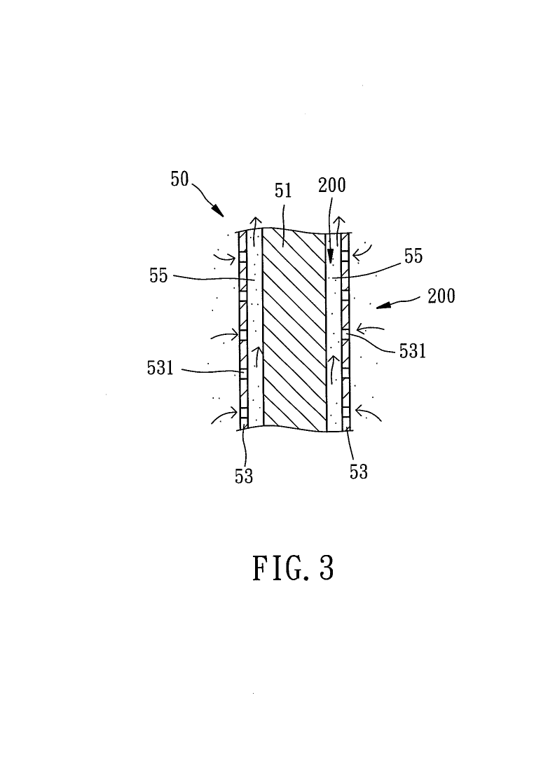

Referring to FIGS. 1-3, a seawater desalination device in accordance with the present invention is shown comprising a seawater reservoir 10, an evaporator 20, multiple osmosis membrane modules 50 and a pump unit 60.

The seawater reservoir 10 is adapted for holding seawater 100, having a bottom wall 13 and a seawater inlet 15.

The evaporator 20 is adapted to evaporate seawater 100 into water vapor 200. According to this embodiment, the evaporator 20 comprises a heater 30 and an atomizer 40. The heater 30 is adapted for heating seawater 100 to the temperature range of 30 °˜80° C.

The osmosis membrane modules 50 are installed in the seawater reservoir 10, and spaced above the bottom wall 13 at a predetermined distance. Further, the osmosis membrane modules 50 are suspending in the seawater reservoir 10 in a parallel manner. Each osmosis membrane module 50 comprises a board 51, two membranes 53 mounted in the board 51, there are multiple fillisters provided on the board 51, a water vapor accumulation chamber 55 defined between the two membranes 53, especially between the membranes 53 and the fillisters of the board 51, and a suction pipe 57 connected to water vapor accumulation chamber 55. Each membrane 53 has a plurality of apertures 531 for the passing of water vapor.

Further, the membranes 53 of the osmosis membrane modules 50 are prepared from polytetrafluoroethylene (PTFE) or expanded polytetrafluoroethylene (ePTFE). Further, the diameter of the apertures 531 of the membranes 53 of the osmosis membrane modules 50 are preferably within the range of 0.05μ˜2μ.

Further, the seawater inlet 15 is disposed below the bottom side 54 of the membranes 53 of the osmosis membrane modules 50.

The pump unit 60 comprises a pipe 61 connected to the suction pipe 57 of each osmosis membrane module 50 for drawing water vapor 200 out of the water vapor accumulation chamber 55 of each osmosis membrane module 50.

The suction pipe 57 of each osmosis membrane module 50 is preferably smoothly arched like a siphon tube, facilitating drawing of water vapor.

Based on the structural characteristics stated above, the seawater desalination device in accordance with the present invention can be modified or enhanced as follows:

For example, a condensing procedure may be employed during or after the step of drawing water vapor out of the water vapor accumulation chamber of each osmosis membrane module to accelerate the seawater desalination speed, or one or a number of drip traps (not shown) may be installed in the pipe 61 of pump unit 60 to let water vapor be condensed into water.

Further, the invention can simply use the heater 30 without the atomizer 40, or simply use the atomizer 40 without the heater 30, achieving conversion of seawater 100 into water vapor 200.

Further, the diameter of the apertures 531 of the membranes 53 of the osmosis membrane modules 50 are most preferably within the range of 0.1˜0.4μ.

Further, modifications can be made to the seawater desalination device as follows:

For example, the board 51 of each osmosis membrane module 50 can be opened and then closed, facilitating replacement of the membranes 53 without hanging the board 51.

Further, the seawater reservoir 10 can be made having an overflow gate (not shown) for allowing seawater to flow over. The elevation of the overflow gate (not shown) is lower than the bottom side 54 of the membranes 53 of the osmosis membrane modules 50.

Further, the osmosis membrane modules 50 are individually detachable, facilitating replacement of every individual osmosis membrane module 50 to maintain the desired working efficiency after a long use.

Further, each osmosis membrane module 50 can be made using only one single membrane 53 that extends around the inside wall of the associating board 51 or surrounds the periphery of the associating board 51.

Based on the description of the aforesaid embodiments of the present invention, the seawater desalination device of the present invention is fully understood. The seawater desalination device is effectively to convert seawater 100 into water vapor 200. The osmosis membrane modules 50 facilitate rapid desalination of seawater 100, avoiding salt content or other substances of seawater 100 from being mixed in desalinated water. Therefore, the invention provides better benefits.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A seawater desalination device, comprising:
a seawater reservoir for holding seawater, said seawater reservoir having a bottom wall;
an evaporator adapted for evaporating the seawater held in said seawater reservoir into water vapor;
a plurality of osmosis membrane modules installed in said seawater reservoir and spaced above said bottom wall of said seawater reservoir at a distance, each said osmosis membrane comprising at least one membrane having a plurality of apertures for the passing of the water vapor evaporated by said evaporator, each of said osmosis membrane provided at least a water vapor accumulation chamber, and a suction pipe connected to said water vapor accumulation chamber; and
a pump unit having a pipe connected to the suction pipe of each said osmosis membrane module and adapted for drawing water vapor out of the water vapor accumulation chamber of each said osmosis membrane module.

2. The seawater desalination device as claimed in claim 1, wherein said evaporator comprises a heater.

3. The seawater desalination device as claimed in claim 2, wherein said evaporator comprises an atomizer.

4. The seawater desalination device as claimed in claim 1, wherein said evaporator comprises an atomizer.

5. The seawater desalination device as claimed in claim 4, wherein said osmosis membrane modules are vertically suspending in said seawater reservoir and arranged in a parallel manner.

6. The seawater desalination device as claimed in claim 3, wherein said osmosis membrane modules are vertically suspending in said seawater reservoir and arranged in a parallel manner.

7. The seawater desalination device as claimed in claim 2, wherein said osmosis membrane modules are vertically suspending in said seawater reservoir and arranged in a parallel manner.

8. The seawater desalination device as claimed in claim 1, wherein said osmosis membrane modules are vertically suspending in said seawater reservoir and arranged in a parallel manner.

9. The seawater desalination device as claimed in claim 2, wherein the apertures of each said membrane of each said osmosis membrane module have a diameter within the range of 0.05μ˜2μ.

10. The seawater desalination device as claimed in claim 9, wherein said membranes of said osmosis membrane modules are prepared from polytetrafluoroethylene (PTFE) or expanded polytetrafluoroethylene (ePTFE).

11. The seawater desalination device as claimed in claim 1, wherein the apertures of each said membrane of each said osmosis membrane module have a diameter within the range of 0.05μ˜2μ.

12. The seawater desalination device as claimed in claim 11, wherein said membranes of said osmosis membrane modules are prepared from polytetrafluoroethylene (PTFE) or expanded polytetrafluoroethylene (ePTFE).

13. The seawater desalination device as claimed in claim 2, wherein the apertures of each said membrane of each said osmosis membrane module preferably have a diameter within the range of 0.1μ˜0.4μ.

14. The seawater desalination device as claimed in claim 1, wherein the apertures of each said membrane of each said osmosis membrane module preferably have a diameter within the range of 0.1μ˜0.4μ.

15. The seawater desalination device as claimed in claim 4, wherein said membranes of said osmosis membrane modules are prepared from polytetrafluoroethylene (PTFE) or expanded polytetrafluoroethylene (ePTFE).

16. The seawater desalination device as claimed in claim 3, wherein said membranes of said osmosis membrane modules are prepared from polytetrafluoroethylene (PTFE) or expanded polytetrafluoroethylene (ePTFE).

17. The seawater desalination device as claimed in claim 2, wherein said membranes of said osmosis membrane modules are prepared from polytetrafluoroethylene (PTFE) or expanded polytetrafluoroethylene (ePTFE).

18. The seawater desalination device as claimed in claim 1, wherein said membranes of said osmosis membrane modules are prepared from polytetrafluoroethylene (PTFE) or expanded polytetrafluoroethylene (ePTFE).

19. The seawater desalination device as claimed in claim 2, wherein said seawater reservoir comprises a seawater inlet disposed at an elevation below a bottom side of each said membrane of each said osmosis membrane module.

20. The seawater desalination device as claimed in claim 1, wherein said seawater reservoir comprises a seawater inlet disposed at an elevation below a bottom side of each said membrane of each said osmosis membrane module.
